(19) United States
(12) Patent Application Publication
(10) Pub. No.: US 2012/0311901 A1
(43) Pub. Date: Dec. 13, 2012

(54) Demountable Display Assembly

(76) Inventors: Peter Maddison, Surry Hills (AU); Anthony Keith Boulton, Clovelly (AU)

(21) Appl. No.: 13/336,610

(22) Filed: Dec. 23, 2011

(30) Foreign Application Priority Data
Dec. 23, 2010 (AU) 2010905613

(51) Int. Cl. G09F 7/18; B23P 17/04

(52) U.S. Cl. 40/600; 29/428; 40/606.01

(57) ABSTRACT

A mounting assembly for enabling the display of an image. The assembly comprises a mounting frame defining an internal recess wherein, the frame is formed by at least one angle shaped edge member having a first leg forming a wall of said recess and a second leg forming a backing for said recess.

A substrate member has a back surface and a front surface; the back surface including fastening means to enable the releasable attachment inside said recess of the substrate member to the frame. The front surface forms a display surface capable of holding an image.

### BACKGROUND

The present invention relates to a display assemblies and more particularly to advertising display assemblies for displaying objects such as but not limited to placards, notices, brochures photographs, artworks and the like. The invention further relates to an assembly in which a display assembly is convertible from a kit or packaged form to an assembled form for ease of removal and transportation. The invention further relates to a method of presenting a display of indicia such as the aforesaid in which a display assembly is assembled and by a series of construction steps following which the display assembly is set to receive the display material. Once assembled display images may be detachably fitted to a support member such as but not limited to a frame. More particularly, the invention provides a kit assembly which displays images against a frame capable of holding replaceable image substrates to support the image.

Although the invention will be described with reference to its application as an assembly for displaying images, it will be recognised that the assembly has a variety of applications not limited to that to be described.

### PRIOR ART

There are already in existence a number of wall mounted and free standing arrangements which allow display of art works and photographs. The prior art teaches various display assemblies. Numerous innovations for artwork and photograph display have been provided in the prior art. Even though these innovations may be suitable for the specific individual purposes to which they address, they differ from the present invention as hereinafter contrasted.

As an example of the prior art, U.S. Pat. No. 6,401,376 discloses a frame type photograph mounting assembly wherein a backing substrate has an adhesive layer on one side and a plurality of retaining pockets on a second side. The retaining pockets are formed to preclude perforation of the backing substrate. The retaining pockets can form a frame extending along two, three or all four sides of the photograph, wherein the retaining pocket engages the retained photograph along at least three sides. This arrangement is cumbersome and does not allow releasable attachment of the photograph.

There is nevertheless a need to provide a means to allow a display assembly in which images and the like may be releasably displayed such that the image can be readily changed for change of display requirements.

In addition there is a long felt want to provide a portable display assembly which allows releasable attachment of a fixed or moving image and which will enable simple attachment and detachment from the frame. Therefore, the need exists for a photo or image retention assembly that can retain a photograph or the like and which allows the photo or image to be released without damage and so that when secured to a frame all boundaries of the image or photo are adequately but releasably retained and without exposing the photograph or image to damaging alternative adhesives. The need also exists for an assembly in which photographs or images may be easily releasably aligned in a support frame eliminating unintended separation of the photograph or image from the frame and also so that none of the image or photo is obscured by the frame.

### INVENTION

The present invention provides a demountable display assembly and more particularly to advertising display assemblies for displaying objects such as but not limited to placards, notices, brochures photographs, artworks and the like. The invention further provides a demountable assembly in which an assembled display is convertible from a kit or packaged form to an assembled form and from an assembled form to a kit or packaged from for ease of removal and transportation. The invention further provides a method of presenting a display of indicia on a display assembled and by a series of construction steps. Once assembled display images may be detachably fitted to the assembly as required. More particularly, the invention provides a kit assembly which enables display of images against a support which allowed displayed images to be replaced as required.

The assembly has a variety of applications not limited to advertising or display of indicia such as signs, photographs, artworks and the like but may also be employed in display of multi media including but not limited to television, internet, on line advertising and cinema.

One configuration of the present invention includes on the display a substrate having an adhesive on one planar back surface that engages an opposing surface of a frame support to retain at least a portion of a periphery of the image displayed.

In one broad form the present invention comprises:

a mounting assembly which is capable of display of a still or moving image, the assembly comprising;

a mounting frame defining an internal recess,

a first panel engagable with the frame providing a back mounting surface,

a second panel engagable with the frame and providing a front mounting surface,

the frame comprising bottom, top and side members;

each said front and back mounting surfaces receiving and retaining a detachable magnetised element which allow releasable attachment of a display element,

wherein the assembly is capable of morphing between a first state in which the assembly is stacked and packaged and a second state in which the assembly is assembled for use.

In its broadest form the present invention comprises:

a mounting assembly which is capable of display of a still or moving image,

the assembly comprising;

a frame defining an internal recess,

a first panel engagable with the frame providing at least one mounting surface, said at least one mounting surface receiving and retaining a detachable magnetised element which allows releasable attachment of a display element,

wherein the assembly is capable of moving between a first state in which the assembly is stacked and packaged and a second state in which the assembly is assembled for use.

According to a preferred embodiment, the bottom, top and side members are detachable and engage via corner brackets. Each side member joins at a first end with an end of the top member and at a second end with an end of the bottom member thereby joining members end to end.

Preferably the frame formed is adapted with a back surface and a front surface; the back surface including means to enable the releasable attachment inside said internal recess of the substrate member to the frame; a display surface capable of holding an image.

According to a preferred embodiment, the display is fastened to the frame by a magnetised strip disposed around the periphery of the frame. The frame may be square, rectangular, triangular polygonal or circular.

In its broadest form the present invention comprises:

a portable display kit capable of assembly into a display unit which is capable of display of a still or moving image, the kit comprising;

a detachable frame defining an internal recess,

a detachable base allowing the frame to be free standing;

a first panel engagable with the frame providing at least one mounting surface,

said at least one mounting surface receiving and retaining a removable display bearing a movable or still image; wherein the assembly is capable of moving between a first state in which the assembly is stacked and packaged and a second state in which the kit is assembled for use.

According to one embodiment, the removable display is a detachable magnetised graphic panel element carrying an image and which allows releasable attachment of a display element,

In another broad form of a method aspect the present invention comprises: a method for display of an image using an assembly manufactured in kit form; the method comprising the steps of;

a) preparing a frame by taking side members, a top and a bottom and engaging the side top and bottom members to form the frame;

b) mounting the frame on a base;

c) providing a first panel which forms a back of the assembly;

d) providing a second panel which forms a front of the assembly;

e) providing a magnetic strip on a back surface of the first panel;

f) providing a magnetic strip on the front surface of the second panel;

g) fitting front and rear graphics display panels bearing a still or moving image to the first and second panels respectively.

The assembly according to one embodiment is fitted via brackets engaging the side arms with a detachable shelf.

The present invention provides a useful alternative to the known display assemblies and devices and although the invention will be described with reference to its application as a free standing floor mountable display for displaying moving or detachable display images from a support it will be recognised that the assembly has a variety of applications not limited to that described. The present invention overcomes shortcomings of and provides an alternative to the known prior art. The foregoing and other objects and advantages will appear from the description to follow. In the description reference is made to the accompanying representations, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying illustrations, like reference characters designate the same or similar parts throughout the several views. The following detailed description is, therefore, not to be taken in a limiting sense, and the scope of the present invention is best defined by the appended claims.

### BRIEF DESCRIPTION OF DRAWINGS

The present invention will now be described in more detail according to a preferred but non limiting embodiment and with reference to the accompanying illustrations; wherein

FIG. 1 shows an exploded perspective view of a mounting assembly according to a preferred embodiment.

FIG. 2 shows an enlarged view of extruded side frame details for shelf connection;

FIG. 3 shows an enlarged view of connection detail of a corner bracket and side rail according to one embodiment; and

FIG. 4 shows an assembled view of the assembly of FIG. 1 with indicia display.

### DETAILED DESCRIPTION

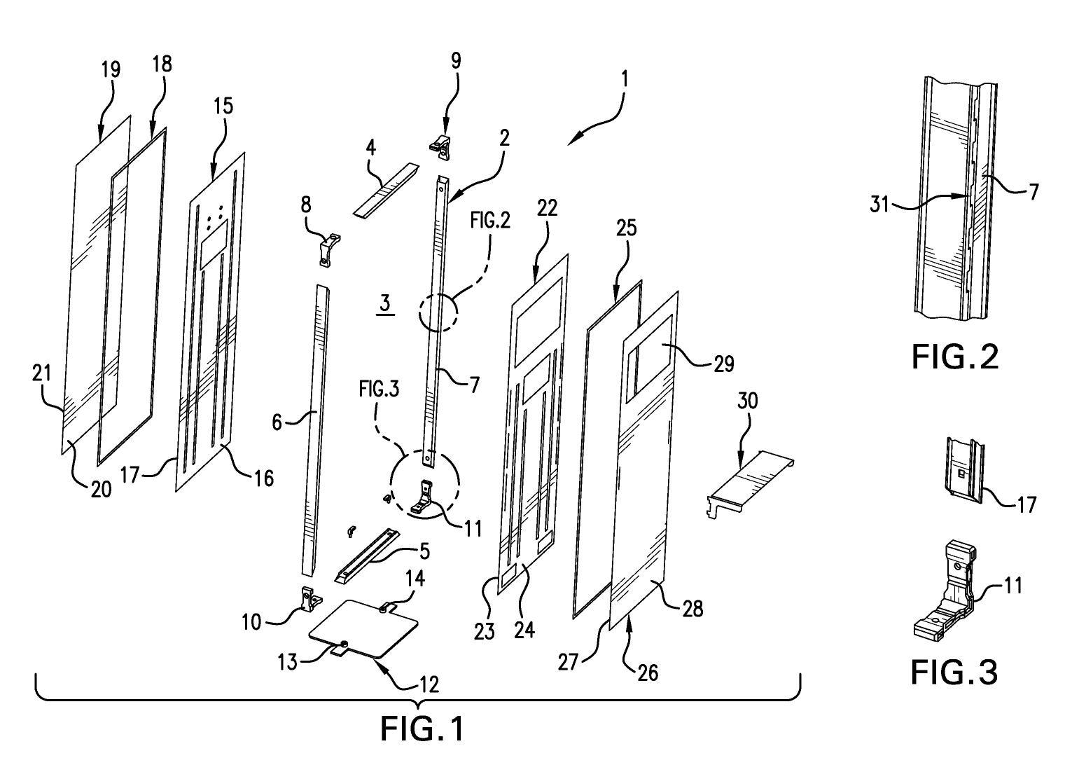

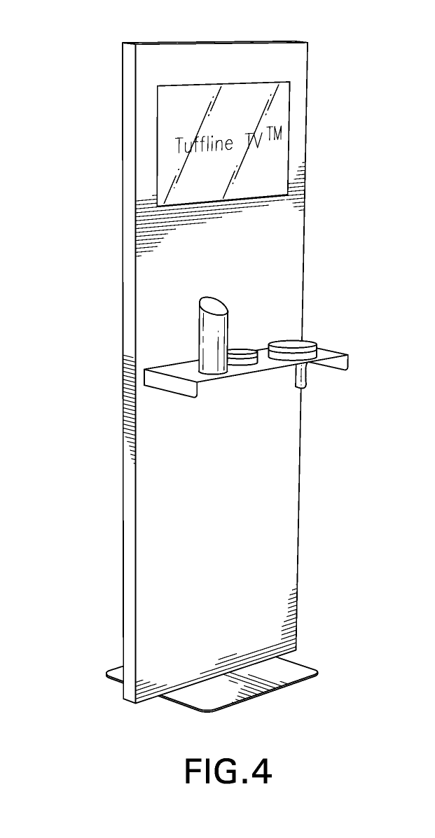

Referring to FIG. 1 there is shown an exploded perspective view of an image mounting assembly 1 which is capable of display of a still or moving image. Assembly 1 comprises a mounting frame 2 defining an internal recess 3. Mounting frame 2 includes top rail 4, bottom rail 5 and side rails 6 and 7. Top rail 4 is detachably connected to side rails 6 and 7 via corner brackets 8 and 9. Bottom rail 5 is connected to respective opposite ends of side rails 6 and 7 via corner brackets 10 and 11. Bottom rail 5 receives and retains a removable mounting base 12 via (preferably quick release) fasteners 13 and 14, which are hidden within recess 3. Mounting frame 2 receives and retains a backing panel 15 having an inner face 16 and outer face 17. Outer face 17 opposes a magnetic strip 18 which receives a display panel 19. Display panel 19 has an inner face 20 which engages the magnetic strip 18 and an outer face 21 which displays a still or moving image for display and /or advertising purposes. Mounting frame 2 receives and retains a front panel 22 having an inner face 23 and outer face 24. Outer face 24 opposes a magnetic strip 25 which receives a display panel 26. Display panel 26 has an inner face 27 which engages the magnetic strip 25 and an outer face 28 which displays a still or moving image for display and /or advertising purposes. Images displayed by panel 26 may cover the whole panel or be confined to a window 29 such as shown in the embodiment of FIG. 1. Magnetised strips 18 and 25 allow releasable attachment of display panels 19 and 26. Assembly one further comprises a shelf 30 which may be detachably fitted to frame 2 on side rails 6 and 7 via slots 31. Shelf 30 is adjustable to any height along rails 6 and 7. FIG. 2 shows an enlarged view of a section of extruded side rail part 7 forming part of frame 2 and including slot 31 details for connection of shelf 30.

Assembly 1 is capable of morphing between a first state in which the assembly is stacked and packaged and a second state in which the assembly is assembled for use. This allows for transportation of the assembly, on site erection and as required disassembly and relocation.

According to one embodiment, the display panel is capable of holding a video monitor which allows the assembly to display a still or moving image, motion picture advertising and the like.

According to a preferred embodiment, the bottom, top and side members are detachable and engage via corner brackets.

It will be appreciated by persons skilled in the art that although frame is described as a generally square configuration, numerous shapes and configurations for the shape of the frame are possible such as but not limited to triangular, rectangular circular or polygonal. Peripheral fame members may be formed alternatively by one continuous member but in the embodiment shown frame comprises tubular members.

The fastening magnetised strips may be disposed randomly about the surface of the panel or about the full periphery of the substrate member or they may be intermittently disposed. Thus the contact area of the magnetised strips may be varied according to engagement requirements. Furthermore the contact area may be varied by using alternatives to the magnetised strips such as but not limited to magnetised pads.

FIG. 3 shows an enlarged view of connection detail of a corner bracket 11 and side rail 7 according to one embodiment;

In use, the assembly may be set up according to the following methodology. Mounting frame 2 is assembled first by engaging top rail 4 with side rails 6 and 7 and bottom rail 5 with the opposite end of rails 6 and 7. Corner brackets 8, 9, 10 and 11 enable engagement of the top, bottom and side rails 4, 5, 6 and 7 respectively. Once frame 2 has been assembled, removable mounting base 12 is attached to bottom rail 5 by the quick release fasteners 13 and 14, which, when the assembly is fully constructed will be hidden within recess 3. Next, backing panel 15 is attached to mounting frame 2 via its inner face 16. Display panel 19 is then engaged magnetic strip 18 via its inner face 20. Outer face 20 is then ready to receive a still or moving image for display and/or advertising purposes. Similarly the front panel 22 is fitted to frame 2. Outer face 24 is fitted with magnetic strip 25 which receives display panel 26. A still or moving image for display and/or advertising purposes is fitted to display panel 26 which displays images. of FIG. 1. Display panels 19 and 26 can be released and re attached to the panel 22 via magnetised strips 18 and 25. Shelf 30 can be optionally fitted to frame 2 on side rails 6 and 7 via slots 31. Shelf 30 can be selectively adjusted as required by changing its position along rails 6 and 7.

The frame may be formed of a different material from or the same material as the substrate. The frame can be formed of a high quality material which reduces degradation to the photograph. The frame preferably engages the image or photograph along three or four sides, thereby enhancing retention of flexible or flimsy photographs. Also according to one embodiment, the frame configuration allows for a selective closure or sealing of the frame to retain the photograph relative to the frame.

It will be recognized by persons skilled in the art that numerous variations and modifications may be made to the invention as broadly described herein without departing from the overall spirit and scope of the invention.

1. A demountable assembly which is capable of display of a still or moving image, the assembly comprising;
a mounting frame which when assembled defines an internal recess,
a first panel engagable with the frame providing a back mounting surface,
a second panel engagable with the frame and providing a front mounting surface,
the frame comprising bottom, top and side rail members;
each said front and back mounting surfaces receiving and retaining a detachable magnetised element which allow releasable attachment of a display element, the display element capable of display of a fixed or moving image,
wherein the assembly is capable of morphing between a first state in which the assembly is stacked and packaged and a second state in which the assembly is assembled for use.

2. A demountable assembly according to claim 1 wherein, the bottom, top and side rail members are detachable and engage via corner brackets.

3. A demountable assembly according to claim 2 wherein each side member joins at a first end with an end of the top member and at a second end with an end of the bottom member thereby joining members end to end.

4. A demountable assembly according to claim 3 wherein the frame formed by the top bottom and side rails receives a first panel forming a back of the assembly and a second panel forming a front of the assembly.

5. A demountable assembly according to claim 4 wherein the back surface includes means to enable the releasable attachment of a display panel capable of displaying an image.

6. A demountable assembly according to claim 5 wherein the front surface includes means to enable the releasable attachment of a display panel capable of displaying an image.

7. A demountable assembly according to claim 6 wherein, the display panel is fastened to the frame by a magnetised strip disposed around the periphery of the frame.

8. A demountable assembly according to claim 7 wherein the frame is selected from the finished shapes square, rectangular, triangular polygonal or circular.

9. a mounting assembly which is capable of display of a still or moving image, the assembly comprising;
a frame defining an internal recess,
a first panel engagable with the frame providing at least one mounting surface, said at least one mounting surface receiving and retaining a detachable magnetised element which allow releasable attachment of a display element,
wherein the assembly is capable of moving between a first state in which the assembly is stacked and packaged and a second state in which the assembly is assembled for use.

10. A portable display kit capable of assembly into a display unit which is capable of display of a still or moving image, the kit comprising;
a detachable frame defining an internal recess,
a detachable base allowing the frame to be free standing;
a first panel engagable with the frame providing at least one mounting surface, said at least one mounting surface receiving and retaining a removable display bearing a movable or still image; wherein the assembly is capable of moving between a first state in which the assembly is stacked and packaged and a second state in which the kit is assembled for use.

11. A portable display kit according to claim 10 wherein, the back surface includes means to enable the releasable attachment of a display panel capable of displaying an image.

12. A portable display kit according to claim according to one claim 11 wherein, the removable display is a detachable magnetised graphic panel element carrying a fixed or moving image and which allows releasable attachment of a display element.

13. A portable display kit wherein the moving image is on a television screen adapted to the display.

14. A method for display of an image using an assembly manufactured in kit form; the method comprising the steps of;
a) preparing a frame by taking side members, a top and a bottom and engaging the side top and bottom members to form the frame;
b) mounting the frame on a base;
c) providing a first panel which forms a back of the assembly;
d) providing a second panel which forms a front of the assembly;
e) providing a magnetic strip on a back surface of the first panel;
f) providing a magnetic strip on the front surface of the second panel;
g) fitting front and rear graphics display panels bearing a still or moving image to the first and second panels respectively.
